(19) United States
(12) Patent Application Publication
(10) Pub. No.: US 2024/0202967 A1
(43) Pub. Date: Jun. 20, 2024

(54) Accelerated Coordinate Encoding: Learning to Relocalize in Minutes Using RBG and Poses

(71) Applicant: Niantic, Inc., San Francisco, CA (US)

(72) Inventors: Tommaso Cavallari, Oxford (GB); Victor Adrian Prisacariu, Oxford (GB); Eric Brachmann, Hanover (DE)

(21) Appl. No.: 18/542,460

(22) Filed: Dec. 15, 2023

Related U.S. Application Data
(60) Provisional application No. 63/433,404, filed on Dec. 16, 2022.

(51) Int. Cl. G06T 7/73

(52) U.S. Cl. CPC G06T 7/73; A63F 13/216; G06T 2207/10024; G06T 2207/20081; G06T 2207/20084; G06T 2207/30244

(57) ABSTRACT

A set of training images of one or more environments and corresponding metadata are received. The metadata includes camera pose and intrinsics. A relocalizer model is trained using the set of training images and the corresponding metadata to generate predict scene coordinates corresponding to pixels in an image of an environment. The relocalizer model includes a scene-agnostic convolutional network and a scene-specific regression network. A set of query images of an environment is received and the trained relocalizer model is applied to the set of query images of the environment to generate predicted scene coordinates corresponding to the pixels in a query image. A pose solver algorithm is applied to the predicted scene coordinates to generate a camera pose.

### BACKGROUND

### 1. Technical Field

The subject matter described relates generally to camera relocalization, and, in particular, to a machine-learned model that uses scene coordinate regression to determine relative pose between images.

### 2. Problem

Camera relocalization generally refers to a process for determining the location and orientation (pose) of a camera within an environment using images captured by the camera. Camera relocalization has a wide and increasing array of uses. In augmented reality (AR) applications, a virtual environment is co-located with a real-world environment. If the pose of a camera capturing images of the real-world environment (e.g., a video feed) is accurately determined, virtual elements can be overlaid on the depiction of the real-world environment with precision, thereby enhancing the user experience. For example, a virtual hat may be placed on top of a real statue, a virtual character may be depicted partially behind a physical object, and the like. Learning-based visual relocalizer algorithms exhibit high pose accuracy, which is ideal for AR applications. However, training these relocalizer algorithms typically require several hours or even days, which makes it an unattractive method for most applications since training is performed for every new scene.

### SUMMARY

The present disclosure describes approaches to camera relocalization that uses Accelerated Coordinate Encoding (ACE), a scene coordinate regression relocalizer that can map a new environment in five minutes, significantly faster than other state-of-the-art methods. The disclosed approach uses a scene coordinate regression relocalizer model that is split into a scene-agnostic convolutional encoder network (e.g., convolutional backbone) and one or more scene-specific multi-level perceptron (MLP) regression heads. Generally, the relocalizer model generates 3D scene coordinates for input image pixels, generating a mapping between the real-world and 2D image information.

The ACE relocalizer model can be trained with two processes. The first training process pre-trains the convolutional backbone while the second training process trains the regression head network on new scenes. In the first training process, the convolutional backbone is pretrained on a training image set which contains images from different environments. For the second training process, the regression head is trained on a new scene in two stages. For the first stage, a buffer generation stage, the convolutional backbone receives training images of a new scene as input, and extracts features from the training images. The ACE relocalizer training system generates a training buffer containing features extracted by the convolutional backbone. The training buffer is only generated once. The second stage, a main training loop, the regression head is trained by iterating over the training buffer, which is shuffled at the beginning of each epoch. The regression head predicts scene coordinates based on the extracted features from the convolutional backbone. The regression heads are trained using a tanh-based reprojection loss function and a circular schedule.

A trained ACE relocalizer model may generate the scene coordinates and provides them to a pose solver algorithm, which produces an estimated camera pose. The camera pose can be used to accurately generate virtual content that seamlessly integrates with the real-world scene captured in the input image.

In contrast to previous state-of-the-art relocalizers, ACE relocalizer system leverages decorrelation of gradients by patch-level training. Accordingly, the ACE relocalizer system significantly reduces the mapping delay, cost, and energy consumption of training a relocalizer model. In one embodiment, the ACE relocalizer model may map a new scene in five minutes or less.

### BRIEF DESCRIPTION OF THE DRAWINGS

FIG. 1 illustrates a networked computing environment, in accordance with one or more embodiments.

FIG. 2 depicts a representation of a virtual world having a geography that parallels the real world, in accordance with one or more embodiments.

FIG. 3 depicts an exemplary game interface of a parallel reality game, in accordance with one or more embodiments.

FIG. 4 is a conceptual diagram that depicts the training process of the ACE relocalizer model, in accordance with one or more embodiments.

FIG. 5 is a flowchart a method for training the scene-specific regression head network, in accordance with one or more embodiments.

FIG. 6 is a flowchart that describes the generation of camera poses, according to one or more embodiments.

FIG. 7 illustrates an example computer system suitable for use in training or applying a depth estimation model, according to one or more embodiments.

The figures and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures.

### DETAILED DESCRIPTION

### Exemplary Location-Based Parallel Reality Gaming System

Various embodiments are described in the context of a parallel reality game that includes augmented reality content in a virtual world geography that parallels at least a portion of the real-world geography such that player movement and actions in the real-world affect actions in the virtual world and vice versa. Those of ordinary skill in the art, using the disclosures provided herein, will understand that the subject matter described is applicable in other situations where determining depth information from image data is desirable. In addition, the inherent flexibility of computer-based systems allows for a great variety of possible configurations, combinations, and divisions of tasks and functionality between and among the components of the system. For instance, the systems and methods according to aspects of the present disclosure can be implemented using a single computing device or across multiple computing devices (e.g., connected in a computer network).

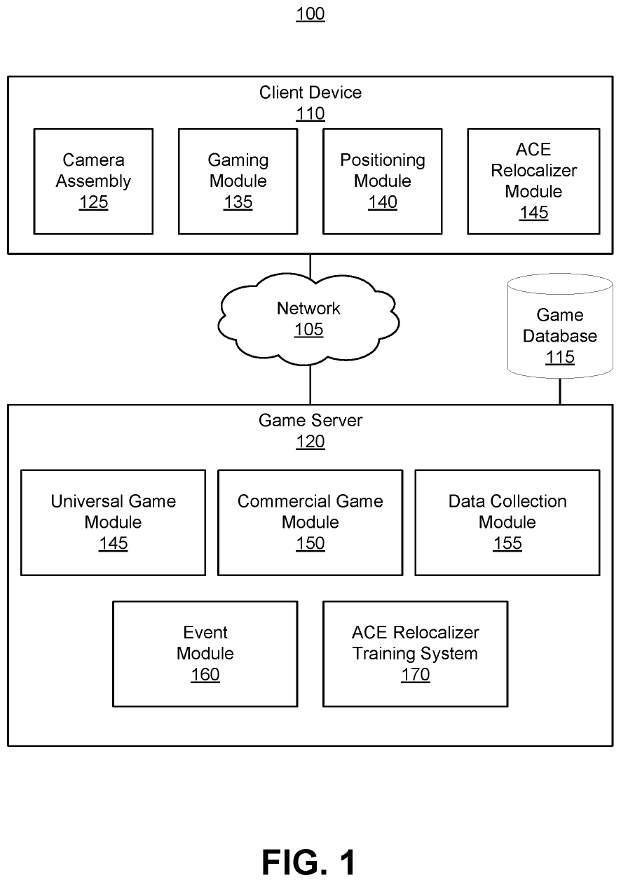

FIG. 1 illustrates a networked computing environment 100, in accordance with one or more embodiments. The networked computing environment 100 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 110 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 110.

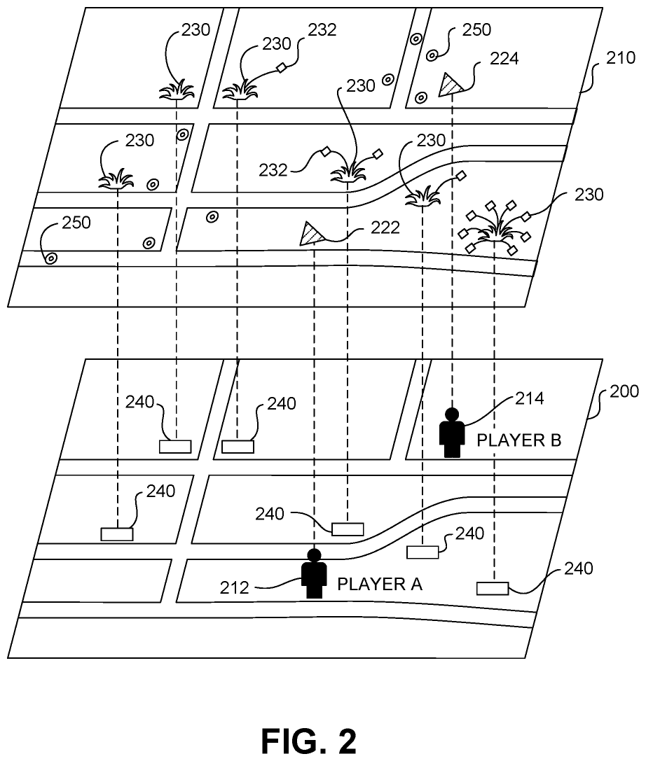

Reference is now made to FIG. 2 which depicts a conceptual diagram of a virtual world 210 that parallels the real world 200 that can act as the game board for players of a parallel reality game, according to one embodiment. As illustrated, the virtual world 210 can include a geography that parallels the geography of the real world 200. In particular, a range of coordinates defining a geographic area or space in the real world 200 is mapped to a corresponding range of coordinates defining a virtual space in the virtual world 210. The range of coordinates in the real world 200 can be associated with a town, neighborhood, city, campus, locale, a country, continent, the entire globe, or other geographic area. Each geographic coordinate in the range of geographic coordinates is mapped to a corresponding coordinate in a virtual space in the virtual world.

A player's position in the virtual world 210 corresponds to the player's position in the real world 200. For instance, the player A located at position 212 in the real world 200 has a corresponding position 222 in the virtual world 210. Similarly, the player B located at position 214 in the real world has a corresponding position 224 in the virtual world. As the players move about in a range of geographic coordinates in the real world, the players also move about in the range of coordinates defining the virtual space in the virtual world 210. In particular, a positioning system (e.g., a GPS system) associated with a mobile computing device carried by the player can be used to track a player's position as the player navigates the range of geographic coordinates in the real world. Data associated with the player's position in the real world 200 is used to update the player's position in the corresponding range of coordinates defining the virtual space in the virtual world 210. In this manner, players can navigate along a continuous track in the range of coordinates defining the virtual space in the virtual world 210 by simply traveling among the corresponding range of geographic coordinates in the real world 200 without having to check in or periodically update location information at specific discrete locations in the real world 200.

The location-based game can include a plurality of game objectives requiring players to travel to and/or interact with various virtual elements and/or virtual objects scattered at various virtual locations in the virtual world. A player can travel to these virtual locations by traveling to the corresponding location of the virtual elements or objects in the real world. For instance, a positioning system can continuously track the position of the player such that as the player continuously navigates the real world, the player also continuously navigates the parallel virtual world. The player can then interact with various virtual elements and/or objects at the specific location to achieve or perform one or more game objectives.

For example, a game objective has players interacting with virtual elements 230 located at various virtual locations in the virtual world 210. These virtual elements 230 can be linked to landmarks, geographic locations, or objects 240 in the real world 200. The real-world landmarks or objects 240 can be works of art, monuments, buildings, businesses, libraries, museums, or other suitable real-world landmarks or objects. Interactions include capturing, claiming ownership of, using some virtual item, spending some virtual currency, etc. To capture these virtual elements 230, a player must travel to the landmark or geographic location 240 linked to the virtual elements 230 in the real world and must perform any necessary interactions with the virtual elements 230 in the virtual world 210. For example, player A of FIG. 2 may have to travel to a landmark 240 in the real world 200 in order to interact with or capture a virtual element 230 linked with that particular landmark 240. The interaction with the virtual element 230 can require action in the real world, such as taking a photograph and/or verifying, obtaining, or capturing other information about the landmark or object 240 associated with the virtual element 230.

Game objectives may require that players use one or more virtual items that are collected by the players in the location-based game. For instance, the players may travel the virtual world 210 seeking virtual items (e.g., weapons, creatures, power ups, or other items) that can be useful for completing game objectives. These virtual items can be found or collected by traveling to different locations in the real world 200 or by completing various actions in either the virtual world 210 or the real world 200. In the example shown in FIG. 2, a player uses virtual items 232 to capture one or more virtual elements 230. In particular, a player can deploy virtual items 232 at locations in the virtual world 210 proximate or within the virtual elements 230. Deploying one or more virtual items 232 in this manner can result in the capture of the virtual element 230 for the particular player or for the team/faction of the particular player.

In one particular implementation, a player may have to gather virtual energy as part of the parallel reality game. As depicted in FIG. 2, virtual energy 250 can be scattered at different locations in the virtual world 210. A player can collect the virtual energy 250 by traveling to the corresponding location of the virtual energy 250 in the actual world 200. The virtual energy 250 can be used to power virtual items and/or to perform various game objectives in the game. A player that loses all virtual energy 250 can be disconnected from the game.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. In some embodiments, players can communicate with one another through one or more communication interfaces provided in the game. Players can also obtain enhanced “powers” or virtual items that can be used to complete game objectives within the game. Those of ordinary skill in the art, using the disclosures provided herein, should understand that various other game features can be included with the parallel reality game without deviating from the scope of the present disclosure.

Referring back FIG. 1, the networked computing environment 100 uses a client-server architecture, where a game server 120 communicates with a client device 110 over a network 105 to provide a parallel reality game to players at the client device 110. The networked computing environment 100 also may include other external systems such as sponsor/advertiser systems or business systems. Although only one client device 110 is illustrated in FIG. 1, any number of clients 110 or other external systems may be connected to the game server 120 over the network 105. Furthermore, the networked computing environment 100 may contain different or additional elements and functionality may be distributed between the client device 110 and the game server 120 in a different manner than described below.

A client device 110 can be any portable computing device that can be used by a player to interface with the game server 120. For instance, a client device 110 can be a wireless device, a personal digital assistant (PDA), portable gaming device, cellular phone, smart phone, tablet, navigation system, handheld GPS system, wearable computing device, a display having one or more processors, or other such device. In another instance, the client device 110 includes a conventional computer system, such as a desktop or a laptop computer. Still yet, the client device 110 may be a vehicle with a computing device. In short, a client device 110 can be any computer device or system that can enable a player to interact with the game server 120. As a computing device, the client device 110 can include one or more processors and one or more computer-readable storage media. The computer-readable storage media can store instructions which cause the processor to perform operations. The client device 110 is preferably a portable computing device that can be easily carried or otherwise transported with a player, such as a smartphone or tablet.

In an embodiment, the client device executes an application allowing the user of the client device 110 to interact with the game server 120 or other components of the system environment 100. For example, a client device 110 can execute an application associated with the parallel reality game to enable interaction between the client device 110 and the game server 120 or other components of the system environment 100 via the network 105. In another embodiment, the client device 110 interacts with the game server 120 or other components of the system environment 100 through an application programming interface (API) running on a native operating system of the client device 110, such as IOS® or ANDROID™.

The client device 110 communicates with the game server 120 providing the game server 120 with sensory data of a physical environment. The client device 110 includes a camera assembly 125 that captures image data in two dimensions of a scene in the physical environment where the client device 110 is. In the embodiment shown in FIG. 1, each client device 110 includes software components such as a gaming module 135 and a positioning module 140. In an embodiment, the client device 110 further includes an Accelerated Coordinate Encoding (ACE) relocalizer module 145. The client device 110 may include various other input/output devices for receiving information from and/or providing information to a player. Example input/output devices include a display screen, a touch screen, a touch pad, data entry keys, speakers, and a microphone suitable for voice recognition. The client device 110 may also include additional sensors for recording data from the environment of the client device 110, the sensors including but not limited to, movement sensors, accelerometers, gyroscopes, other inertial measurement units (IMUs), barometers, positioning systems, thermometers, light sensors, microphones, etc.

The client device 110 can further include a network interface (not shown) for providing communications over the network 105. A network interface can include any suitable components for interfacing with one more networks, including for example, transmitters, receivers, ports, controllers, antennas, or other suitable components.

The camera assembly 125 captures image data of a scene of the environment where the client device 110 is in. The camera assembly 125 may utilize a variety of varying photo sensors with varying color capture ranges at varying capture rates. The camera assembly 125 may contain a wide-angle lens or a telephoto lens. The camera assembly 125 may be configured to capture single images or video as the image data. Additionally, the orientation of the camera assembly 125 could be parallel to the ground with the camera assembly 125 aimed at the horizon. The camera assembly 125 captures image data and shares the image data with the computing device on the client device 110. The image data can be appended with metadata describing other details of the image data including sensory data (e.g., temperature, brightness of environment) or capture data (e.g., exposure, warmth, shutter speed, focal length, capture time, etc.). The camera assembly 125 can include one or more cameras which can capture image data. In one instance, the camera assembly 125 comprises one camera and is configured to capture monocular image data. In another instance, the camera assembly 125 comprises two cameras and is configured to capture stereoscopic image data. In various other implementations, the camera assembly 125 comprises a plurality of cameras each configured to capture image data.

The gaming module 135 provides a player with an interface to participate in the parallel reality game. The game server 120 transmits game data over the network 105 to the client device 110 for use by the gaming module 135 at the client device 110 to provide local versions of the game to players at locations remote from the game server 120. The game server 120 can include a network interface for providing communications over the network 105. A network interface can include any suitable components for interfacing with one more networks, including for example, transmitters, receivers, ports, controllers, antennas, or other suitable components.

The gaming module 135 executed by the client device 110 provides an interface between a player and the parallel reality game. The gaming module 135 can present a user interface on a display device associated with the client device 110 that displays a virtual world (e.g., renders imagery of the virtual world) associated with the game and allows a user to interact in the virtual world to perform various game objectives. In some other embodiments, the gaming module 135 presents image data from the real world (e.g., captured by the camera assembly 125) augmented with virtual elements from the parallel reality game. In these embodiments, the gaming module 135 may generate virtual content and/or adjust virtual content according to other information received from other components of the client device 110. For example, the gaming module 135 may adjust a virtual object to be displayed on the user interface according to a depth map of the scene captured in the image data.

The gaming module 135 can also control various other outputs to allow a player to interact with the game without requiring the player to view a display screen. For instance, the gaming module 135 can control various audio, vibratory, or other notifications that allow the player to play the game without looking at the display screen. The gaming module 135 can access game data received from the game server 120 to provide an accurate representation of the game to the user. The gaming module 135 can receive and process player input and provide updates to the game server 120 over the network 105. The gaming module 135 may also generate and/or adjust game content to be displayed by the client device 110. For example, the gaming module 135 may generate a virtual element based on depth information.

The positioning module 140 can be any device or circuitry for monitoring the position of the client device 110. For example, the positioning module 140 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, and/or other suitable techniques for determining position. The positioning module 140 may further include various other sensors that may aid in accurately positioning the client device 110 location.

As the player moves around with the client device 110 in the real world, the positioning module 140 tracks the position of the player and provides the player position information to the gaming module 135. The gaming module 135 updates the player position in the virtual world associated with the game based on the actual position of the player in the real world. Thus, a player can interact with the virtual world simply by carrying or transporting the client device 110 in the real world. In particular, the location of the player in the virtual world can correspond to the location of the player in the real world. The gaming module 135 can provide player position information to the game server 120 over the network 105. In response, the game server 120 may enact various techniques to verify the client device 110 location to prevent cheaters from spoofing the client device 110 location. It should be understood that location information associated with a player is utilized only if permission is granted after the player has been notified that location information of the player is to be accessed and how the location information is to be utilized in the context of the game (e.g., to update player position in the virtual world). In addition, any location information associated with players will be stored and maintained in a manner to protect player privacy.

The ACE relocalizer module 145 communicates with the game server 120 to provide the position and orientation (e.g., pose) of the camera in an environment to the gaming module. The ACE relocalizer module 145 receives sensor data from various sensors on the client device and processes the sensor data. The ACE relocalizer module 145 receives images of the environment from the camera assembly 125 and other sensor data associated with each image from the other sensors on the client device 110. The ACE relocalizer module 145 sends the sensor data and a request to determine the camera pose to the game server over the network 105 using a communication protocol. The game server 120 determines the camera pose of the client device based on the predicted scene coordinates output by a trained ACE relocalizer model, and provides the camera pose to the ACE relocalizer module 145 on the client device 110.

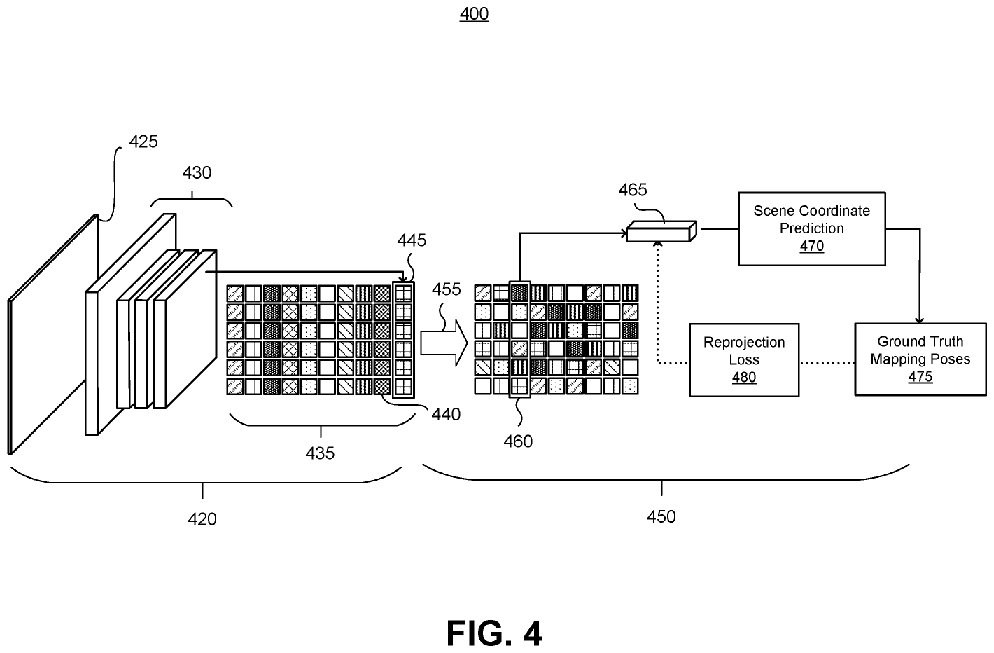

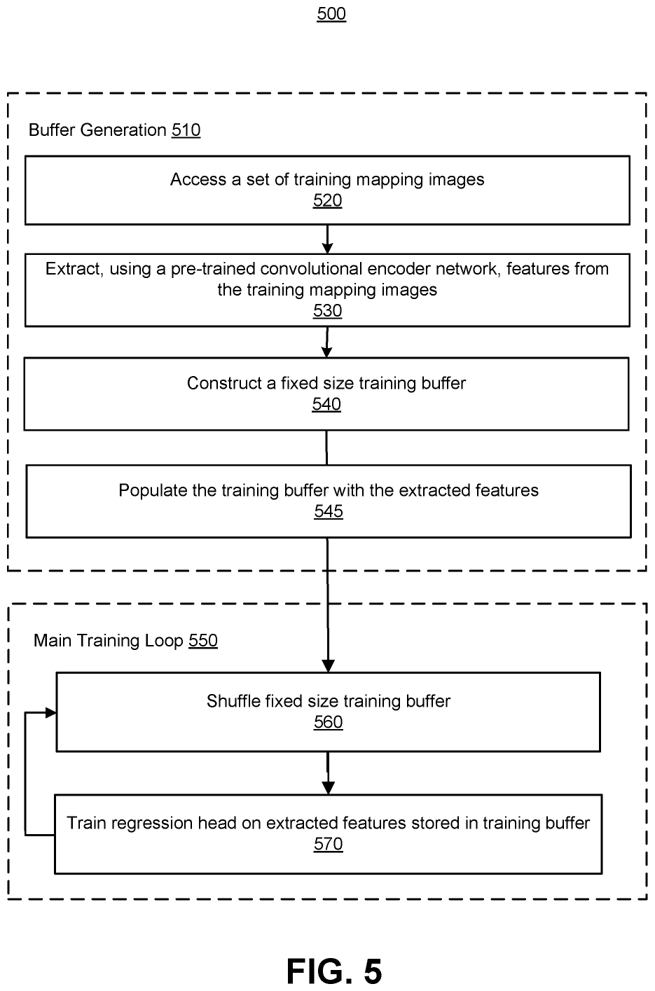

The ACE relocalizer module 145 may provide the camera pose to the gaming module 135, to enable the gaming module 135 to accurately generate virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly. Additional details of embodiments of the ACE relocalizer model are described in FIGS. 4 and 5.

The game server 120 can be any computing device and can include one or more processors and one or more computer-readable storage media. The computer-readable storage media can store instructions which cause the processor to perform operations. The game server 120 can include or can be in communication with a game database 115. The game database 115 stores game data used in the parallel reality game to be served or provided to the client(s) 110 over the network 105.

The game data stored in the game database 115 can include: (1) data associated with the virtual world in the parallel reality game (e.g. imagery data used to render the virtual world on a display device, geographic coordinates of locations in the virtual world, etc.); (2) data associated with players of the parallel reality game (e.g. player profiles including but not limited to player information, player experience level, player currency, current player positions in the virtual world/real world, player energy level, player preferences, team information, faction information, etc.); (3) data associated with game objectives (e.g. data associated with current game objectives, status of game objectives, past game objectives, future game objectives, desired game objectives, etc.); (4) data associated virtual elements in the virtual world (e.g. positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) Game status (e.g. current number of players, current status of game objectives, player leaderboard, etc.); (7) data associated with player actions/input (e.g. current player positions, past player positions, player moves, player input, player queries, player communications, etc.); and (8) any other data used, related to, or obtained during implementation of the parallel reality game. The game data stored in the game database 115 can be populated either offline or in real time by system administrators and/or by data received from users/players of the system 100, such as from a client device 110 over the network 105.

The game server 120 can be configured to receive requests for game data from a client device 110 (for instance via remote procedure calls (RPCs)) and to respond to those requests via the network 105. For instance, the game server 120 can encode game data in one or more data files and provide the data files to the client device 110. In addition, the game server 120 can be configured to receive game data (e.g. player positions, player actions, player input, etc.) from a client device 110 via the network 105. For instance, the client device 110 can be configured to periodically send player input and other updates to the game server 120, which the game server 120 uses to update game data in the game database 115 to reflect any and all changed conditions for the game.

In the embodiment shown, the game server 120 includes a universal gaming module 135, a commercial game module 150, a data collection module 155, an event module 160, and an ACE relocalizer training system 170. As mentioned above, the game server 120 interacts with a game database 115 that may be part of the game server 120 or accessed remotely (e.g., the game database 115 may be a distributed database accessed via the network 105). In other embodiments, the game server 120 contains different and/or additional elements. In addition, the functions may be distributed among the elements in a different manner than described. For instance, the game database 115 can be integrated into the game server 120.

The universal game module 135 hosts the parallel reality game for all players and acts as the authoritative source for the current status of the parallel reality game for all players. As the host, the universal game module 135 generates game content for presentation to players, e.g., via their respective client devices 110. The universal game module 135 may access the game database 115 to retrieve and/or store game data when hosting the parallel reality game. The universal game module 135 also receives game data from client device 110 (e.g. depth information, player input, player position, player actions, landmark information, etc.) and incorporates the game data received into the overall parallel reality game for all players of the parallel reality game. The universal game module 135 can also manage the delivery of game data to the client device 110 over the network 105. The universal game module 135 may also govern security aspects of client device 110 including but not limited to securing connections between the client device 110 and the game server 120, establishing connections between various client device 110, and verifying the location of the various client device 110.

The commercial game module 150, in embodiments where one is included, can be separate from or a part of the universal game module 135. The commercial game module 150 can manage the inclusion of various game features within the parallel reality game that are linked with a commercial activity in the real world. For instance, the commercial game module 150 can receive requests from external systems such as sponsors/advertisers, businesses, or other entities over the network 105 (via a network interface) to include game features linked with commercial activity in the parallel reality game. The commercial game module 150 can then arrange for the inclusion of these game features in the parallel reality game.

The game server 120 can further include a data collection module 155. The data collection module 155, in embodiments where one is included, can be separate from or a part of the universal game module 135. The data collection module 155 can manage the inclusion of various game features within the parallel reality game that are linked with a data collection activity in the real world. For instance, the data collection module 155 can modify game data stored in the game database 115 to include game features linked with data collection activity in the parallel reality game. The data collection module 155 can also analyze and data collected by players pursuant to the data collection activity and provide the data for access by various platforms.

The event module 160 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The ACE relocalizer training system 170 generates an estimated pose of the client device camera based on captured images of an environment. The ACE relocalizer training system 170 may train ACE relocalizer models, using a process that is described in FIGS. 4 and 5. A trained ACE relocalizer model is configured to generate an estimated pose of the camera based on received captured image data. In an embodiment, the game server 120 deploys the trained ACE relocalizer models. In other embodiments, the trained ACE relocalizer models may be deployed by a model serving system (not pictured). The ACE relocalizer training system 170 communicates with the model serving system through an API or other communication protocols. The ACE relocalizer training system 170 sends requests for predictions to the ACE relocalizer model, receives the predictions generated by the ACE relocalizer model, and provides the results to the ACE relocalizer module 145 on the client device. The model serving system may be managed by another entity, and there may be different instances of the model serving system deploying a respective model (e.g., ACE relocalizer model) deployed by a respective entity.

In other embodiments, an ACE relocalizer model may be deployed on the client device. The trained ACE relocalizer model may be provided to the client device 110 and the ACE relocalizer module 145 may include functionality to load and initialize the ACE relocalizer model on the client device 110 to perform inference.

The network 105 can be any type of communications network, such as a local area network (e.g. intranet), wide area network (e.g. Internet), or some combination thereof. The network can also include a direct connection between a client device 110 and the game server 120. In general, communication between the game server 120 and a client device 110 can be carried via a network interface using any type of wired and/or wireless connection, using a variety of communication protocols (e.g. TCP/IP, HTTP, SMTP, FTP), encodings or formats (e.g. HTML, XML, JSON), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

In addition, in situations in which the systems and methods discussed herein access and analyze personal information about users, or make use of personal information, such as location information, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Exemplary Game Interface

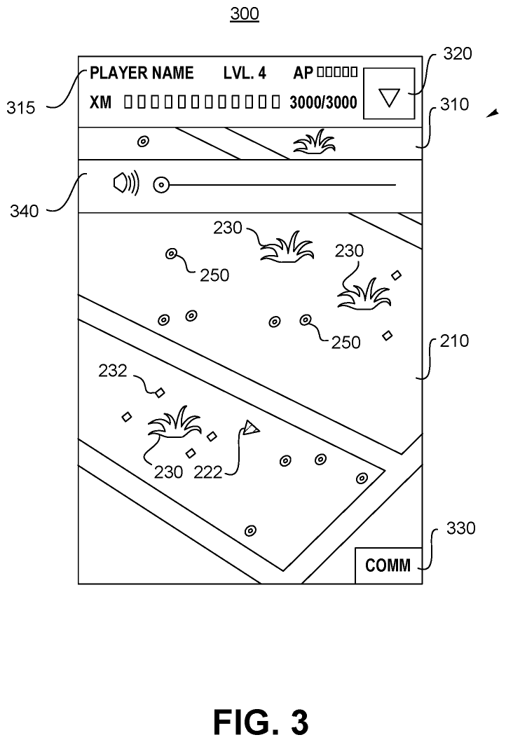

FIG. 3 depicts one embodiment of a game interface 300 that can be presented on a display of a client as part of the interface between a player and the virtual world 210. The game interface 300 includes a display window 310 that can be used to display the virtual world 210 and various other aspects of the game, such as player position 222 and the locations of virtual elements 230, virtual items 232, and virtual energy 250 in the virtual world 210. The user interface 300 can also display other information, such as game data information, game communications, player information, client location verification instructions and other information associated with the game. For example, the user interface can display player information 315, such as player name, experience level and other information. The user interface 300 can include a menu 320 for accessing various game settings and other information associated with the game. The user interface 300 can also include a communications interface 330 that enables communications between the game system and the player and between one or more players of the parallel reality game.

According to aspects of the present disclosure, a player can interact with the parallel reality game by simply carrying a client device 110 around in the real world. For instance, a player can play the game by simply accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 300 can include a plurality of non-visual elements that allow a user to interact with the game. For instance, the game interface can provide audible notifications to the player when the player is approaching a virtual element or object in the game or when an important event happens in the parallel reality game. A player can control these audible notifications with audio control 340. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

Those of ordinary skill in the art, using the disclosures provided herein, will appreciate that numerous game interface configurations and underlying functionalities will be apparent in light of this disclosure. The present disclosure is not intended to be limited to any one particular configuration.

### Example Methods

FIG. 4 is a conceptual diagram that depicts the training process of the ACE relocalizer model, in accordance with one or more embodiments. As described above, the ACE relocalizer training system 170 may use a trained ACE relocalizer model to perform scene coordinate prediction, and subsequently determine the camera pose of the client device to accurately generate virtual content.

Generally, a camera pose h can be estimated given a single RGB image I, based on the 3D scene coordinates generated by the ACE relocalizer model and the corresponding 2D pixel positions of the input image. The camera pose is defined as a rigid body transformation that maps coordinates in a camera space eᵢ to coordinates in a scene space yᵢ, therefore yᵢ=heᵢ. The camera pose can be estimated from the image-to-scene correspondences:

$$h = g ( C ) , with C = \{ ( {x}_{i} , {y}_{i} ) \} \qquad ( 1 )$$

where C is the set of correspondences between 2D pixel positions xᵢ and 3D scene coordinates yᵢ, and function g represents a robust pose solver, which may be a PnP minimal solver in a RANSAC loop followed by refinement.

Scene coordinate regression may be used to obtain image-to-scene correspondences. A function ƒ (e.g., ACE relocalizer model) to predict 3D scene points for any 2D image location is learned, represented by:

$${y}_{i} = f ( {p}_{i} ; w ) , with {p}_{i} = P ( {x}_{i} , I ) \qquad ( 2 )$$

where ƒ is parametrized by learnable weights w. The function ƒ receives an image patch pᵢ extracted around pixel position xᵢ from mapping image I and produces a 3D coordinate yᵢ. Thus, ƒ implements a mapping from patches to coordinates, ƒ: R^{C}^{₁}^{×H}^{_{P}}^{×W}^{_{P}}→R³.

In the example ACE relocalizer model depicted in FIG. 4, the ACE relocalizer model is a coordinate regression model that includes a convolutional backbone and a regression head. The convolutional backbone 430 may be implemented using a scene-agnostic convolutional network, and the regression head 465 may be implemented as a scene specific regression multi-layer perceptron (MLP) head. The overall model is represented by:

$$f ( {p}_{i} ; w ) = {f}_{H} ( {f}_{i} ; {w}_{H} ) , with {f}_{i} = {f}_{B} ( {p}_{i} ; {w}_{B} ) \qquad ( 3 )$$

where ƒ_{B} is the convolutional backbone 430 that predicts a high-dimensional feature ƒᵢ with dimensionality C_{F}, and ƒ_{H} is the MLP regression head 465 that predicts 3D scene coordinates yᵢ based on the feature ƒᵢ. This can be further represented by:

$${f}_{B} : {R}^{{C}_{I} \times {H}_{P} \times {W}_{P}} \to {R}^{{C}_{f}} and {f}_{H} : {R}^{{C}_{f}} \to {R}^{3} \qquad ( 4 )$$

where ƒ_{B} outputs a feature tensor, and ƒ_{H} processes the feature tensor to generate the scene coordinates. RGB images or grayscale images with C_{I}=1 may be used as input. The training process of the ACE relocalizer model is explained below.

In general, the ACE relocalizer model is learned by optimizing over all mapping images I_{M} with the ground truth poses h*ᵢ as supervision, represented below:

$${arg min}_{w} {\sum }_{I ∈ {I}_{M}} {\sum }_{i} {l}_{π} [ {x}_{i} , {\overbrace{f ( {p}_{i} ; w )}}^{{y}_{i}} , {h}_{i}^{*} ] \qquad ( 5 )$$

where l_{π} is a reprojection loss. Equation 5 is optimized using minibatch stochastic gradient descent, which updates the model parameters based on the gradient of loss with respect to a small subset of the training data. The neural network predicts dense scene coordinates from one mapping image at a time, with all predictions supervised using the ground truth mapping pose.

In an embodiment, the ACE relocalizer training system 170 trains the ACE relocalizer model in two stages, the first stage including pre-training the convolutional backbone, and the second stage including training the MLP regression heads on a new scene. For the first stage, the ACE relocalizer training system 170 pre-trains the convolutional backbone 430 on input images from different environments, the convolutional backbone 430 trained on an N number of scenes in parallel. The convolutional backbone 430 may be trained using image-level training and curriculum training, with a pixel-wise reprojection loss function. This is described in further detail below in the description of FIG. 5.

For the second stage, the ACE relocalizer training system 170 trains the one or more MLP regression heads 465 attached to the convolutional backbone, each MLP regression head on a new scene. The training process of the MLP regression heads 465 can be further divided into two stages, the buffer generation stage 420 and the main training loop 450. In the buffer generation stage 420, a fixed sized training buffer 435 is constructed. The ACE relocalizer training system 170 constructs the training buffer 435 by passing the mapping images 425 through the convolutional backbone 430 that extracts high-dimensional feature vectors. Each feature 440 is represented by a box in the training buffer 435, and features from the same mapping image 445 are illustrated with a similar pattern fill. The training buffer 435 is generated once in the first minute of training.

The main training loop 450 outlines the training process for the scene specific MLP regression heads 465 on new scenes, the regression heads 465 configured to predict the scene coordinates based on features generated by the convolutional backbone. At the beginning of each epoch, the training buffer 435 is shuffled 455 to mix features 440 (e.g., patches) across all mapping data. At each training step, training batches 460 are constructed with several thousand random features and the associated mapping poses, and a parameter update over thousands of mapping views is computed at once. By randomizing the patches over the entire training set and constructing training batches from many different mapping views, the gradients are decorrelated within a batch and leads to a very stable training signal, robustness to high learning rates, and fast convergence. This also increases efficiency for gradient computation for the MLP regression head 465.

The MLP regression head 465 makes a scene coordinate prediction 470. A tanh-based pixel-wise reprojection loss function is used to calculate a reprojection loss 480, which measures the difference between the predicted scene coordinates and the ground truth scene coordinates 475. The reprojection loss is used to train the MLP regression head 465 to minimize error between the predicted scene coordinates and the ground truth scene coordinates.

FIG. 5 is a flowchart that describes a method for training the scene-specific regression head network, in accordance with one or more embodiments. The method 500 yields a trained MLP regression head that generates predicted scene coordinates for the image pixels. The steps of FIG. 5 are illustrated from the perspective of the ACE relocalizer training system 170 performing the method 500. However, some or all of the steps may be performed by other entities and/or components. In addition, some embodiments may perform the steps in parallel, perform the steps in different orders, or perform different steps.

Prior to method 500, as described in FIG. 4, the convolutional backbone 430 is pretrained using a set of training mapping images. The convolutional backbone 430 may be any dense feature description network with descriptors that are distinctive for any position in the input image. In an embodiment, the backbone architecture consists of the first N number of layers (e.g., N=10, including skip connections) of the DSAC* network design.

The convolutional backbone 430 is trained on a set of training mapping images with N regression heads for N scenes, in parallel. For example, the convolutional backbone 430 may be trained on one hundred scenes in parallel and attaches one hundred regression heads to its end. The set of training mapping images may be acquired from users. The training images may be collected while users scan wayspots or other locations of interest while playing games, or from any relevant third-party entity (e.g., developers interested in using the relocalization service API). The set of training images contains images from multiple scenes. A portion of the set of training images may be heavily augmented, through various methods such as brightness and contrast jitter, saturation and hue jitter, image warping and random re-scaling of images. The backbone may be trained with half-precision floating point weights.

In an embodiment, the convolutional backbone 430 is trained using an image-level training approach, and is combined with curriculum training to mimic end-to-end training. Accordingly, the network can focus on good predictions and neglect less precise predictions that would be filtered by RANSAC during pose estimation. The training loss based on the pixel-wise reprojection loss is represented by:

$${l}_{π} [ {x}_{i} , {y}_{i} , {h}_{i}^{*} ] = \{ \begin{matrix}{\hat{e}}_{π} ( {x}_{i} , {y}_{i} , {h}_{i}^{*} ) & if {y}_{i} ∈ V \\ {‖ {y}_{i} - {\overline{y}}_{i} ‖}_{0} & Otherwise\end{matrix} . \qquad ( 6 )$$

where a robust reprojection error ê_{π} is optimized for all valid coordinate predictions V. Valid predictions are within a range (e.g., 10 cm and 1000 m) in front of the image plane, and have a reprojection error below a threshold (e.g., 1000 px). For invalid predictions, the reprojection loss optimizes the distance to a dummy scene coordinate y̅ᵢ that is calculated from the ground truth camera pose assuming a fixed image depth (e.g., 10 m). Accordingly, the pre-trained backbone is used to extract dense descriptors on any new scene, the extracted descriptors used to train the regression heads, described below by method 500.

As described in FIG. 4, the MLP regression heads 465 are trained during a second stage of training which is depicted by FIG. 5. In an embodiment, the MLP regression head 465 is composed of 8 1×1 convolutional layers, of width 512, with skip connections after layer 3 and 6; followed by a final 1×1 convolutional layer that produces the scene coordinates. The regression head layers may use half-precision floating point weights. The MLP regression heads may be configured to directly regress the scene coordinates or regress homogenous coordinates. In the former case, the last layer would output a 3-channel tensor, while in the latter case, the last layer would output a 4D tensor (\dot{x},\dot{y},ż,ŵ), with \dot{y}=(\dot{x},\dot{y},ż)^{T} being the homogeneous representation of the 3D scene coordinates, and ŵ∈R being an unnormalized homogeneous parameter. w∈R⁺ is calculated from ŵ by applying a biased and clipped Softplus operator to ŵ, and the scene coordinates are subsequently de-homogenized. Specifically, w may be calculated as follows:

$$w = min ( \frac{1}{{S}_{min}} , {β}^{- 1} \cdot log ( 1 + exp ( β \cdot \hat{w} ) ) + \frac{1}{{S}_{max}} ) \qquad ( 7 )$$

where Sₘᵢₙ and Sₘₐₓ are used to clip the scale factor determined by w, and β is a parameter used to ensure that when the network outputs ŵ=0, the resulting homogeneous parameter w=1.

Accordingly, the network is steered towards producing a neutral homogeneous parameter, wherein it is centered on 1. In an embodiment,

$$β = \frac{log ( 2 )}{1 - {S}_{max}^{- 1}} .$$

The output of the network is de-homogenized into the tensor y containing 3D scene coordinates:

$$y = \frac{\dot{y}}{w} \qquad ( 8 )$$

For both the cases of direct regression the scene coordinates and regression of homogenous coordinates, the coordinates output by the network are learned relatively to the “mean” translation of the camera poses associated to the mapping frames for numerical stability.

As described in FIG. 4, the MLP regression head network may be trained in two stages: a buffer generation stage 510, and a main training loop 550. During the buffer generation stage 510, the ACE relocalizer training system accesses 520 a set of training mapping images depicting new scenes to be mapped. The training images are augmented using a similar approach that is used in the convolutional backbone training. The training images may be augmented with different (e.g., weaker) data augmentation parameters, if the convolutional backbone was already trained on strongly augmented images.

The ACE relocalizer training system provides the training mapping images to the pretrained convolutional backbone, which extracts 530 features from the training images. The ACE relocalizer training system constructs 540 a fixed size training buffer. For example, the buffer may contain 8 million 512-channel patch descriptors, along with the associated 2D location in the source image, mapping camera pose, and intrinsic parameters. The ACE relocalizer training system populates 545 the training buffer with extracted high-dimensional feature vectors produced by the convolutional backbone. For each training mapping image processed by the convolutional backbone, an M number (e.g., M=1024) of patches and corresponding feature descriptors are randomly selected to be copied into the training buffer, along with other metadata (e.g., 2D patch location, camera pose and intrinsics). In another embodiment, feature selection is not random, and instead, the features may be assigned a score (or weight) computed by the ACE relocalizer model. For example, the relocalizer model may assign different scores to different features in an image, allowing it to emphasize important information. Accordingly, the features selected to be copied into the training buffer may have a higher score assigned compared to other features. Thus, the regression heads are trained on more important regions of the image.

During the main training loop 550, at the beginning of each epoch, the training buffer is shuffled 560 to mix features (or patches) across all mapping data. The regression head is trained 570 on extracted features stored in the training buffer. As described above, the regression head is trained by repeatedly iterating over the shuffled training buffer. Shuffling the training buffer randomizes patches over the entire training set, and constructs training batches from many different mapping views. Accordingly, reducing correlation between gradients within a batch, and leading to a stable training signal, robustness to high learning rates, and, ultimately, fast convergence. In one embodiment, the regression head is trained for sixteen epochs to achieve state-of-the-art accuracy in five minutes or less.

As described in FIG. 4, the MLP regression heads 465 may be trained using a tanh-based loss function on reprojection errors. The function may be dynamically rescaled according to a circular schedule with a threshold decreasing throughout the length of the training process. This is represented below:

$${\hat{e}}_{π} ( {x}_{i} , {y}_{i} , {h}_{i}^{*} ) = τ ( t ) tanh ( \frac{{e}_{π} ( {x}_{i} , {y}_{i} , {h}_{i}^{*} )}{τ ( t )} ) \qquad ( 9 )$$

where τ represents a threshold of reprojection error e_{π}. The tanh function is dynamically rescaled according to the threshold τ that varies throughout training, represented below:

$$τ ( t ) = w ( t ) {τ}_{max} + {τ}_{min} , with w ( t ) = \sqrt{1 - {t}^{2}} \qquad ( 10 )$$

where t∈(0, 1) denotes the relative training progress. This curriculum implements a circular schedule of threshold τ, which remains close to τₘₐₓ at the beginning of training, and declines towards τₘᵢₙ at the end of training.

Additionally, the entire network may be trained with half-precision floating point weights, which results in an additional speed boost. The neural networks may also be stored with float16 precision, which allows an increase in the depth of our regression heads while maintaining small (e.g., 4 MB) maps. In conjunction with the curriculum training, a one cycle learning rate schedule can be used (e.g., increasing the learning rate in the middle of training and reducing it towards the end). An advantage was observed in overparameterizing the scene coordinate representation by predicting the homogeneous coordinates y′=(x,y,z,w)^{T} and applying a w-clip, enforcing w to be positive by applying a Softplus operation.

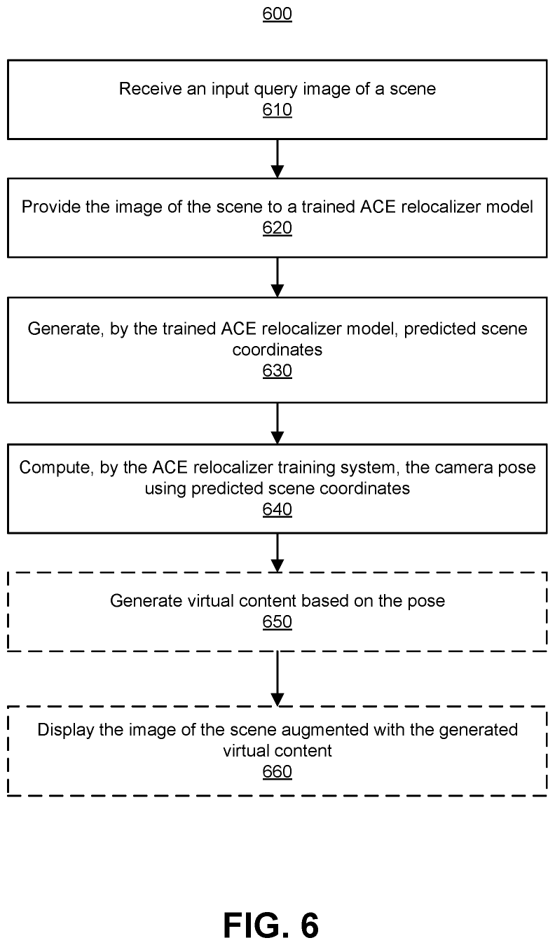

FIG. 6 is a flowchart that describes the generation of camera poses, according to one or more embodiments. The method 600 results in an estimated pose for an input query image. The steps of FIG. 6 are illustrated from the perspective of the game server and a client device performing the method 600. However, some or all of the steps may be performed by other entities and/or components. In addition, some embodiments may perform the steps in parallel, perform the steps in different orders, or perform different steps.

The client device receives 610 an input query image of a scene. The input query image (e.g., RGB image) may be captured by the camera assembly 125 of the client device 110. The input query image may also have intrinsics corresponding to the geometric properties of the camera that captured the image. The client device provides 620 the input query image to a trained ACE relocalizer model. As described above, the ACE relocalizer model may be trained by the ACE relocalizer training system 170, e.g., via the method described in FIG. 5. The ACE relocalizer model receives the input query image, and, in some embodiments, the intrinsics of the image. The trained ACE relocalizer model generates 630 predicted scene coordinates for the image pixels, producing the correspondence between the 3D scene coordinates and the 2D pixel positions.

The ACE relocalizer training system computes 640 the camera pose using the predicted scene coordinates generated by the ACE relocalizer model. As described in FIG. 4, a camera pose h is calculated using a robust pose solver g using the correspondence between the 3D scene coordinates and the pixels of the image. The pose solver may include a PnP minimal solver in a RANSAC loop, or other known algorithms, and is followed by refinement. Refinement consists iterative optimization of the reprojection error over all RANSAC inliers using a known optimization algorithm, such as Levenberg-Marquardt.

The ACE relocalizer training system 170 returns the resulting camera pose to the client device over the network. The ACE relocalizer module may provide the camera pose to the gaming module to generate 650 virtual content for a parallel reality game. The client device 110 displays 660 the image of the scene or a constant video feed augmented with the virtual content to a user. For example, a physical object may be augmented with virtual content that interacts with the physical object.

### Example Computing System

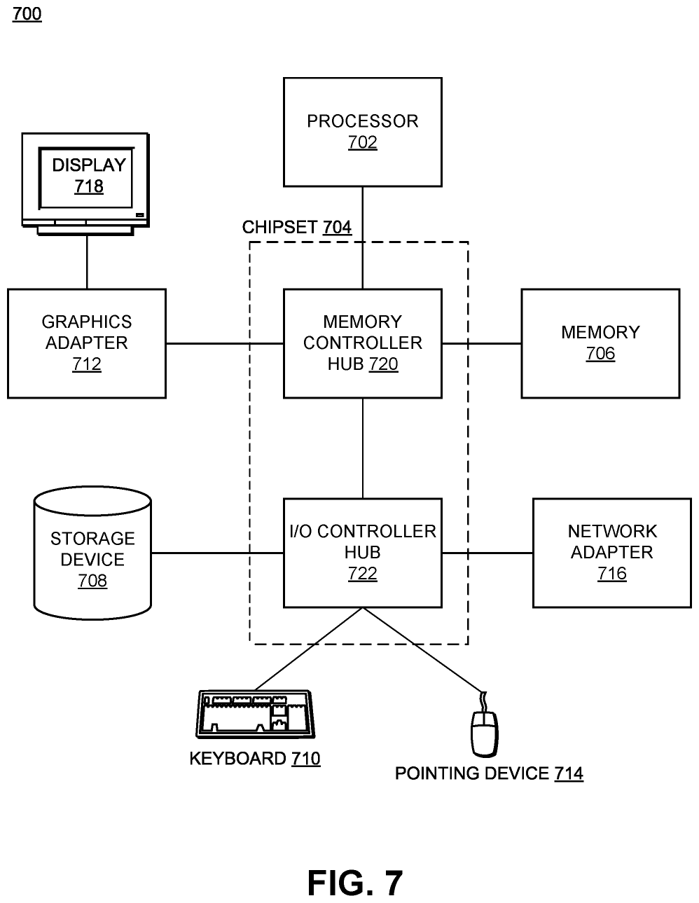

FIG. 7 is an example architecture of a computing device, according to an embodiment. Although FIG. 7 depicts a high-level block diagram illustrating physical components of a computer used as part or all of one or more entities described herein, in accordance with an embodiment, a computer may have additional, less, or variations of the components provided in FIG. 7. Although FIG. 7 depicts a computer 700, the figure is intended as functional description of the various features which may be present in computer systems than as a structural schematic of the implementations described herein. In practice, and as recognized by those of ordinary skill in the art, items shown separately could be combined and some items could be separated.

Illustrated in FIG. 7 are at least one processor 702 coupled to a chipset 704. Also coupled to the chipset 704 are a memory 706, a storage device 708, a keyboard 710, a graphics adapter 712, a pointing device 714, and a network adapter 716. A display 718 is coupled to the graphics adapter 712. In one embodiment, the functionality of the chipset 704 is provided by a memory controller hub 720 and an I/O hub 722. In another embodiment, the memory 706 is coupled directly to the processor 702 instead of the chipset 704. In some embodiments, the computer 700 includes one or more communication buses for interconnecting these components. The one or more communication buses optionally include circuitry (sometimes called a chipset) that interconnects and controls communications between system components.

The storage device 708 is any non-transitory computer-readable storage medium, such as a hard drive, compact disk read-only memory (CD-ROM), DVD, or a solid-state memory device or other optical storage, magnetic cassettes, magnetic tape, magnetic disk storage or other magnetic storage devices, magnetic disk storage devices, optical disk storage devices, flash memory devices, or other non-volatile solid state storage devices. Such a storage device 708 can also be referred to as persistent memory. The pointing device 714 may be a mouse, track ball, or other type of pointing device, and is used in combination with the keyboard 710 to input data into the computer 700. The graphics adapter 712 displays images and other information on the display 718. The network adapter 716 couples the computer 700 to a local or wide area network.

The memory 706 holds instructions and data used by the processor 702. The memory 706 can be non-persistent memory, examples of which include high-speed random-access memory, such as DRAM, SRAM, DDR RAM, ROM, EEPROM, flash memory.

As is known in the art, a computer 700 can have different and/or other components than those shown in FIG. 7. In addition, the computer 700 can lack certain illustrated components. In one embodiment, a computer 700 acting as a server may lack a keyboard 710, pointing device 714, graphics adapter 712, and/or display 718. Moreover, the storage device 708 can be local and/or remote from the computer 700 (such as embodied within a storage area network (SAN)).

As is known in the art, the computer 700 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 708, loaded into the memory 706, and executed by the processor 702.

### Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for verifying an account with an on-line service provider corresponds to a genuine business. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

1. A method, comprising:
receiving a set of training images of one or more environments and corresponding metadata, the metadata comprising camera pose and intrinsics;
training, by a relocalizer training system, a relocalizer model using the set of training images and corresponding metadata, the relocalizer model configured to predict scene coordinates corresponding to pixels in an image of an environment; wherein the relocalizer model comprises a scene-agnostic convolutional network and a scene-specific regression network;
receiving a set of query images of an environment;
applying, by the relocalizer training system, a trained relocalizer model to the set of query images of the environment to generate predicted scene coordinates corresponding to the pixels in a query image; and
applying, by the relocalizer training system, a pose solver algorithm to the predicted scene coordinates to generate a camera pose.

2. The method of claim 1, wherein the scene-agnostic convolutional network of the relocalizer model is pre-trained on the set of training images of one or more environments and corresponding metadata using image-level training and curriculum training.

3. The method of claim 1, wherein the relocalizer model includes more than one scene-specific regression network attached to an end of the scene-agnostic convolutional network.

4. The method of claim 1, wherein the relocalizer training system trains the scene-specific regression network in a buffer generation stage and a main training loop stage.

5. The method of claim 4, wherein the buffer generation stage of training the scene-specific regression network includes:
accessing a set of training images of an environment;
applying the scene-agnostic convolutional network to the set of training images to extract features from the training images;
constructing a fixed sized training buffer; and
populating the fixed sized training buffer by copying the extracted features from the training images into the training buffer.

6. The method of claim 4, wherein the main training loop stage of training the scene-specific regression network includes:
shuffling entries of the training buffer at a beginning of each epoch;
generating training batches, each training batch including random features and associated mapping poses; and
training the scene-specific regression network using the training batches.

7. The method of claim 1, wherein the scene-specific regression network is trained using a tanh-based reprojection loss function and a circular schedule with a threshold decreasing throughout a training process.

8. A non-transitory computer-readable medium comprising stored instructions that, when executed by one or more computing devices, cause the one or more computing devices to collectively:
receive a set of training images of one or more environments and corresponding metadata, the metadata comprising camera pose and intrinsics;
train a relocalizer model using the set of training images, the relocalizer model configured to predict scene coordinates corresponding to pixels in an image of an environment; wherein the relocalizer model comprises a scene-agnostic convolutional network and a scene-specific regression network;
receive a set of query images of an environment;
apply a trained relocalizer model to the set of query images of the environment to generate predicted scene coordinates corresponding to the pixels in the query image; and
apply a pose solver algorithm to the predicted scene coordinates to generate a camera pose.

9. The non-transitory computer-readable medium of claim 8, wherein the scene-agnostic convolutional network of the relocalizer model is pre-trained on the set of training images of one or more environments and corresponding metadata using image-level training and curriculum training.

10. The non-transitory computer-readable medium of claim 8, wherein the relocalizer model includes more than one scene-specific regression network attached to an end of the scene-agnostic convolutional network.

11. The non-transitory computer-readable medium of claim 8, wherein the scene-specific regression network is trained in a buffer generation stage and a main training loop stage.

12. The non-transitory computer-readable medium of claim 11, wherein the buffer generation stage comprises instructions that, when executed by a processor, cause the processor to:
accessing a set of training images of an environment;
applying the scene-agnostic convolutional network to the set of training images to extract features from the training images;
constructing a fixed sized training buffer; and
populating the fixed sized training buffer by copying the extracted features from the training images into the training buffer.

13. The non-transitory computer-readable medium of claim 11, wherein the main training loop comprises instructions that, when executed by a processor, cause the processor to:
shuffling entries of the training buffer at a beginning of each epoch;
generating training batches, each training batch including random features and associated mapping poses; and
training the scene-specific regression network using the training batches.

14. The non-transitory computer-readable medium of claim 8, wherein the scene-specific regression network is trained using a tanh-based reprojection loss function and a circular schedule with a threshold decreasing throughout a training process.

15. A computer system, comprising:
one or more computer processors; and
one or more memories comprising stored instructions that when executed by the one or more computer processors causes the computer system to:
receive a set of training images of one or more environments and corresponding metadata, the metadata comprising camera pose and intrinsics;
train a relocalizer model using the set of training images, the relocalizer model configured to predict scene coordinates corresponding to pixels in an image of an environment; wherein the relocalizer model comprises a scene-agnostic convolutional network and a scene-specific regression network;
receive a set of query images of an environment;
apply a trained relocalizer model to the set of query images of the environment to generate predicted scene coordinates corresponding to the pixels in the query image; and
apply a pose solver algorithm to the predicted scene coordinates to generate a camera pose.

16. The computer system of claim 15, wherein the scene-agnostic convolutional network of the relocalizer model is pre-trained on the set of training images of one or more environments and the corresponding metadata using image-level training and curriculum training.

17. The computer system of claim 15, wherein the relocalizer model includes more than one scene-specific regression network attached to an end of the scene-agnostic convolutional network.

18. The computer system of claim 15, wherein the scene-specific regression network is trained in a buffer generation stage and a main training loop stage.

19. The computer system of claim 18, wherein the buffer generation stage comprises instructions that, when executed by a processor, cause the processor to:
accessing a set of training images of an environment;
applying the scene-agnostic convolutional network to the set of training images to extract features from the training images;
constructing a fixed sized training buffer; and
populating the fixed sized training buffer by copying the extracted features from the training images into the training buffer.

20. The computer system of claim 18, wherein the main training loop comprises instructions that, when executed by a processor, cause the processor to:
shuffling entries of the training buffer at a beginning of each epoch;
generating training batches, each training batch including random features and associated mapping poses; and
training the scene-specific regression network using the training batches.
